(19) United States
(12) Patent Application Publication
(10) Pub. No.: US 2025/0225054 A1
(43) Pub. Date: Jul. 10, 2025

(54) SYSTEMS AND METHODS FOR SECURELY IDENTIFYING DEFICIENCIES IN SOFTWARE CODE

(71) Applicant: INVISV, Inc., Marina Del Ray, CA (US)

(72) Inventors: Barath RAGHAVAN, Irvine, CA (US); Paul SCHMITT, Honolulu, HI (US)

(73) Assignee: INVISV, Inc., Marina Del Ray, CA (US)

(21) Appl. No.: 18/405,448

(22) Filed: Jan. 5, 2024

(51) Int. Cl. G06F 11/36

(52) U.S. Cl. CPC G06F 11/3608

(57) ABSTRACT

An exemplary method for securely identifying deficiencies in software code comprises: receiving, from a user device, a user query comprising obfuscated user software code data and a user-specified software code portion specification; obtaining, based on the user-specified software code portion specification, one or more obfuscated reference software code data structures constructed from reference software code associated with one or more predefined deficiencies; comparing the obfuscated user software code data with the one or more obfuscated reference software code data structures; if the obfuscated user software code data matches at least one of the obfuscated reference software code data structures, identifying the one or more predefined deficiencies in the obfuscated user software code data; and providing an indication of the identified one or more predefined deficiencies to the user device for flagging.

### FIELD

The present disclosure relates generally to systems and methods for analyzing software code for a user while maintaining confidentiality of the user and the software source code, and more specifically to systems and methods for securely identifying deficiencies in software source code.

### BACKGROUND

Many software developers may, with or without their knowledge, produce software programs that include software code that partially or completely corresponds to software code associated with other entities (e.g., software code produced by other software developers, software code owned by other organizations, software code generated by machine-learning algorithms). For example, sample software code may be generated automatically using machine learning or AI models such as large language models (LLMs), templates, or rules in integrated development environments (IDEs) or with other software development tools, and provided to software developers for incorporation into the software code they are producing. Additionally, software developers may obtain software code from external sources, such as online repositories of open-source software code.

Software code that partially or completely corresponds to other entities may be considered to be deficient in several aspects. For example, the machine learning models used to generate software code may be trained on publicly available software code, which may be under one or more undesirable licenses or restrictions, and the trained machine learning models may produce software code similar or identical to the software code under the undesirable licenses or restrictions. In another example, software code produced by a machine learning model or obtained from an external source may contain one or more vulnerabilities (e.g., vulnerabilities that were flagged in a software vulnerability disclosure). Furthermore, software code produced by a machine learning model or obtained from an external source may contain software code that has been copyrighted.

Thus, to mitigate the legal and business risks, software developers and organizations employing the software developers may need to verify that the software code they are producing or using is not deficient in some way. For example, the organization may want to ensure that the software code is not subject to any copyright or trademark restrictions, is not under a software license, or does not have any known vulnerabilities. However, existing methods of software code analysis involve sending the software code to a third party to be checked for deficiencies. Doing so exposes the user's proprietary raw software code to the third party, thus creating a risk that the third party may use or reveal the software code, either purposefully or inadvertently (e.g., by getting hacked or by experiencing a data breach).

### SUMMARY

Disclosed herein are systems, methods, electronic devices, non-transitory storage media, and apparatuses for identifying deficiencies in software code for a user while maintaining confidentiality of the user and the software code. A code checking system may analyze a user's software code for deficiencies such as licenses, copyright and trademark restrictions, and known vulnerabilities without obtaining an actual copy of the user's raw proprietary software code, thus maintaining the confidentiality of the software code and the user. The code checking system can receive a user query comprising obfuscated user software code data (e.g., hash values corresponding to the user software code) and compare the obfuscated user software code data to one or more obfuscated reference software code data structures (e.g., a probabilistic software data structure such as a Bloom filter) corresponding to reference software code from various sources, such as public repositories of open-source software code. The reference software code may be known to contain one or more deficiencies. If the code checking system detects a match between the obfuscated user software code and one or more obfuscated reference software code data structures, the code checking system can identify the deficiencies in the obfuscated user software code and provide an indication of those deficiencies to a user. For example, the identified one or more deficiencies and the portion of the user software code (e.g., lines of user software codes) that contains the deficiencies are flagged in a software development environment at the user device for user revision/correction. The IDE can further recommend new code to replace the deficient software code portion. The code checking system can be run locally or on an inexpensive cloud server using efficient, compact data structures, allowing the comparison to be accomplished within a short period of time (e.g., milliseconds).

The techniques described herein provide several technical advantages. For example, the code checking system described herein may analyze user software code for deficiencies without obtaining an actual copy of the user's raw proprietary software code, thus maintaining the confidentiality of the user and the user software code and preventing the user software code from being shared externally. Further, the code checking system may verify software code generated by machine learning models and software code obtained from external sources and allow software developers and organizations to safely use the verified software code without exposing themselves to unnecessary business and legal risks. Further, the code checking system may allow software developers and organizations to quickly identify which portions of their software code include deficiencies and provide notes and recommendations to addressing the deficiencies. In addition, the code checking system may include obfuscated reference software code data structures corresponding to multiple terabytes worth of software code, which may enable the code checking system to perform comprehensive software code analysis accurately and efficiently using the data structures best suited for the particular analysis. The data structures used may be compact yet include a high level of content, which facilitates real-time analysis. Furthermore, the code checking system described herein may be run locally or remotely on an inexpensive cloud server, which may further improve the cost-effectiveness and efficiency of the code checking system. Moreover, the techniques described herein may improve the functioning of a computer. The code checking system may perform code analysis efficiently and accurately, thus reducing battery usage, processor usage, and memory usage of the computer system for checking a large volume of software code.

In some embodiments, a method for securely identifying deficiencies in software code may be provided, wherein the method comprises: by a code checking system: receiving, from a user device, a user query comprising obfuscated user software code data and a user-specified software code portion specification; obtaining, based on the user-specified software code portion specification, one or more obfuscated reference software code data structures constructed from reference software code associated with one or more predefined deficiencies; comparing the obfuscated user software code data with the one or more obfuscated reference software code data structures; if the obfuscated user software code data matches at least one of the obfuscated reference software code data structures, identifying the one or more predefined deficiencies in the obfuscated user software code data; and providing an indication of the identified one or more predefined deficiencies to the user device for flagging, in a software development environment at the user device, one or more lines of user software code associated with the obfuscated user software code data.

In some embodiments, the one or more obfuscated reference software code data structures are constructed by: extracting, via a rolling window having a specification equivalent to the user-specified software code portion specification, a plurality of reference software code portions from the reference software code; and constructing the one or more obfuscated reference software code data structures by obfuscating the plurality of reference software code portions.

In some embodiments, each reference software code portion of the plurality of reference software code portions comprises the same number of lines of software code, and each reference software code portion has overlapping lines of software code with a neighboring reference software code portion.

In some embodiments, the obfuscated user software code data is generated at the user device by: extracting, at the user device, a plurality of user software code portions from the user software code; and constructing obfuscated user software code data by obfuscating the plurality of user software code portions.

In some embodiments, each user software code portion comprises the same number of lines of software code, and each user software code portion has no overlapping lines of software code with a neighboring user software code portion.

In some embodiments, the one or more lines of user software code associated with the obfuscated user software code data are not accessible by the code checking system.

In some embodiments, the one or more lines of user software code associated with the obfuscated user software code data are generated by a machine-learning or AI model.

In some embodiments, the one or more predefined deficiencies comprise: one or more copyright restrictions, one or more trademark restrictions, one or more licenses, one or more vulnerabilities, or any combination thereof.

In some embodiments, the method further comprises normalizing the reference software code.

In some embodiments, normalizing the reference software code comprises: removing one or more whitespaces from the reference software code, removing one or more comments from the reference software code, removing one or more special symbols from the reference software code, reformatting the reference software code, renaming one or more parameters or identifiers in the reference software code, or any combination thereof.

In some embodiments, the one or more obfuscated reference software code portions are obfuscated by performing a cryptographic hash function on each reference software code portion of the plurality of reference software code portions.

In some embodiments, each obfuscated reference software code data structure of the one or more obfuscated reference software code data structures comprises a Bloom filter, a Cuckoo filter, a Ribbon filter, an XOR filter, or a Binary Fuse Filter.

In some embodiments, the user query comprises a plurality of parameters comprising: one or more programming languages to check, one or more code licenses to check, one or more organizations to check, one or more normalization rules, or any combination thereof.

In some embodiments, the one or more obfuscated reference software code data structures are selected based on the plurality of parameters in the user query.

In some embodiments, flagging the one or more lines of user software code associated with the obfuscated user software code data comprises highlighting, marking, or annotating the one or more lines of user software code.

In some embodiments, the plurality of reference software code portions are obfuscated using an Oblivious RAM-based technique, a Homomorphic encryption technique, a Private Information Retrieval protocol, or a Secure Multiparty Computation Protocol (SMCP).

In some embodiments, the code checking system is installed on the user device or one or more remote devices.

In some embodiments, the code checking system is automatically triggered by the software development environment or IDE.

In some embodiments, a system for securely identifying deficiencies in software code may be provided, wherein the system comprises one or more processors configured to cause the system to: receive, from a user device, a user query comprising obfuscated user software code data and a user-specified software code portion specification; obtain, based on the user-specified software code portion specification, one or more obfuscated reference software code data structures constructed from reference software code associated with one or more predefined deficiencies; compare the obfuscated user software code data with the one or more obfuscated reference software code data structures; if the obfuscated user software code data matches at least one of the obfuscated reference software code data structures, identify the one or more predefined deficiencies in the obfuscated user software code data; and provide an indication of the identified one or more predefined deficiencies to the user device for flagging, in a software development environment at the user device, one or more lines of user software code associated with the obfuscated user software code data.

In some embodiments, a non-transitory computer readable storage medium may be provided, the non-transitory computer readable storage medium storing instructions that, when executed by one or more processors of an electronic device, cause the device to: receive, from a user device, a user query comprising obfuscated user software code data and a user-specified software code portion specification; obtain, based on the user-specified software code portion specification, one or more obfuscated reference software code data structures constructed from reference software code associated with one or more predefined deficiencies; compare the obfuscated user software code data with the one or more obfuscated reference software code data structures; if the obfuscated user software code data matches at least one of the obfuscated reference software code data structures, identify the one or more predefined deficiencies in the obfuscated user software code data; and provide an indication of the identified one or more predefined deficiencies to the user device for flagging, in a software development environment at the user device, one or more lines of user software code associated with the obfuscated user software code data.

In some embodiments, any of the features of any of the embodiments described above and/or described elsewhere herein may be combined, in whole or in part, with one another.

Additional advantages will be readily apparent to those skilled in the art from the following detailed description. The aspects and descriptions herein are to be regarded as illustrative in nature and not restrictive.

### BRIEF DESCRIPTION OF THE FIGURES

Various aspects of the disclosed methods and systems are set forth with particularity in the appended claims. A better understanding of the features and advantages of the disclosed methods and systems will be obtained by reference to the following detailed description of illustrative embodiments and the accompanying drawings, of which:

FIG. 1 illustrates an exemplary system for securely identifying deficiencies in software code, according to some embodiments.

FIG. 2 illustrates an exemplary method for securely identifying deficiencies in software code, according to some embodiments.

FIG. 3 illustrates obfuscation of an exemplary code portion, according to some embodiments.

FIG. 4A illustrates an exemplary indication of an identified deficiency in software code, according to some embodiments.

FIG. 4B illustrates an exemplary indication of an identified deficiency in software code, according to some embodiments.

FIG. 4C illustrates an exemplary indication of an identified deficiency in software code, according to some embodiments.

FIG. 5 illustrates an exemplary computing system, according to some embodiments.

### DETAILED DESCRIPTION

Disclosed herein are systems, methods, electronic devices, non-transitory storage media, and apparatuses for identifying deficiencies in software code for a user while maintaining confidentiality of the user and the software code. A code checking system may analyze a user's software code for deficiencies such as licenses, copyright and trademark restrictions, and known vulnerabilities without obtaining an actual copy of the user's raw proprietary software code, thus maintaining the confidentiality of the software code and the user. The code checking system can receive a user query comprising obfuscated user software code data (e.g., hash values corresponding to the user software code) and compare the obfuscated user software code data to one or more obfuscated reference software code data structures (e.g., a probabilistic software data structure such as a Bloom filter) corresponding to reference software code from various sources, such as public repositories of open-source software code. The reference software code may be known to contain one or more deficiencies. If the code checking system detects a match between the obfuscated user software code and one or more obfuscated reference software code data structures, the code checking system can identify the deficiencies in the obfuscated user software code and provide an indication of those deficiencies to a user. For example, the identified one or more deficiencies and the portion of the user software code (e.g., lines of user software codes) that contains the deficiencies are flagged in a software development environment at the user device for user revision/correction. The IDE can further recommend new code to replace the deficient software code portion. The code checking system can be run locally or on an inexpensive cloud server using efficient, compact data structures, allowing the comparison to be accomplished within a short period of time (e.g., milliseconds).

The techniques described herein provide several technical advantages. For example, the code checking system described herein may analyze user software code for deficiencies without obtaining an actual copy of the user's raw proprietary software code, thus maintaining the confidentiality of the user and the user software code and preventing the user software code from being shared externally. Further, the code checking system may verify software code generated by machine learning models and software code obtained from external sources and allow software developers and organizations to safely use the verified software code without exposing themselves to unnecessary business and legal risks. Further, the code checking system may allow software developers and organizations to quickly identify which portions of their software code include deficiencies and provide notes and recommendations to addressing the deficiencies. In addition, the code checking system may include obfuscated reference software code data structures corresponding to multiple terabytes worth of software code, which may enable the code checking system to perform comprehensive software code analysis accurately and efficiently using the data structures best suited for the particular analysis. The data structures used may be compact yet include a high level of content, which facilitates real-time analysis. Furthermore, the code checking system described herein may be run locally or remotely on an inexpensive cloud server, which may further improve the cost-effectiveness and efficiency of the code checking system. Moreover, the techniques described herein may improve the functioning of a computer. The code checking system may perform code analysis efficiently and accurately, thus reducing battery usage, processor usage, and memory usage of the computer system for checking a large volume of software code.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly dictates otherwise. It is also to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are accorded the scope consistent with the claims.

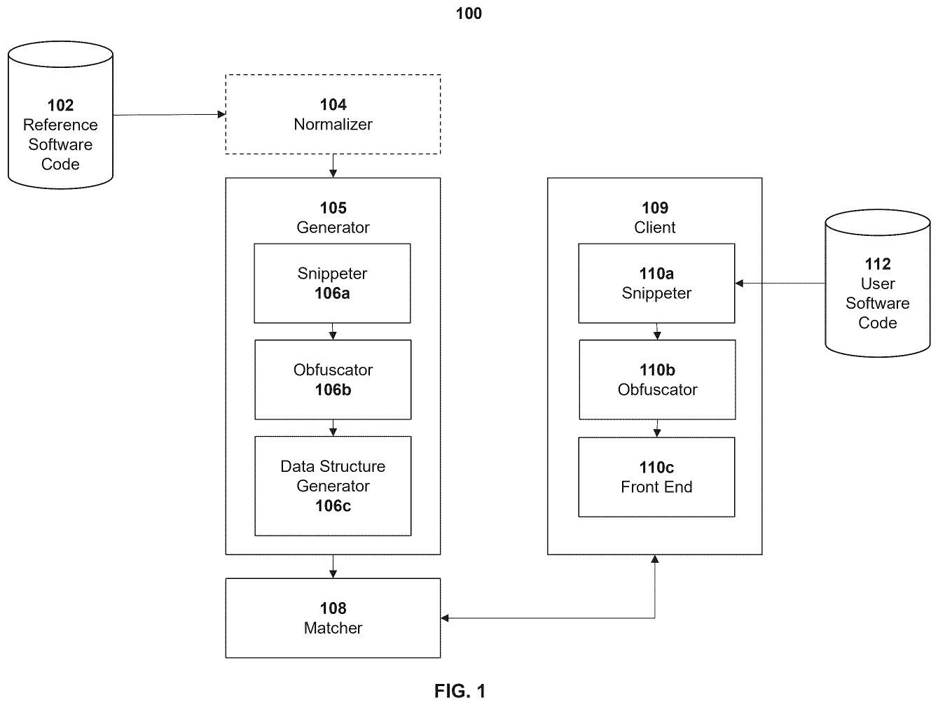

FIG. 1 illustrates an exemplary system 100 for securely identifying deficiencies in software code, according to some embodiments. System 100 may include one or more repositories for storing reference software code 102. Reference software code 102 may include publicly available software code known to have one or more deficiencies. For instance, reference software code 102 may include one or more software programs under known licenses, one or more software programs under copyright or trademark restrictions, or one or more software programs with known vulnerabilities. With reference to FIG. 1, the system 100 comprises a normalizer 104 for normalizing the reference software code 102 and a generator 105 for generating a plurality of reference software code data structures based on the normalized reference software code. Generator 105 may include snippeter 106a, obfuscator 106b, and data structure generator 106c. Snippeter 106a can extract a plurality of reference software code portions from the normalized reference software code. Obfuscator 106b can obfuscate the plurality of reference software code portions. Data structure generator 106c can construct one or more obfuscated reference software code data structures. The system 100 further comprises a client 109 for accessing user software code 112 and generating obfuscated user software code data. The system further includes a matcher 108 that can compare one or more of the reference software code data structures (from the generator 105) against the obfuscated user software code data to identify deficiencies. The matcher 108 can provide the identified deficiencies to the client 109 for display, as described in detail herein.

In some embodiments, the client 109 can be located at one or more user devices that store or otherwise have access to user software code 112 that needs to be checked, while the normalizer 104 and the generator 105 may be located at one or more remote electronic devices (e.g., servers) that are communicatively coupled to the client 109, for example, via a communication network. The matcher 108 can be located locally on the same user device(s) as the client 109, or on a remote electronic device that is communicatively coupled to the client 109. Regardless of where matcher 108 is located, matcher 108 requires only the obfuscated user software code data (e.g., provided by the client 109) and the obfuscated reference software code data structures (e.g., provided by the generator 105) to check user software code for deficiencies. Matcher 108 does not require user software code 112 in order to identify the deficiencies, thus maintaining the confidentiality of the user software code 112. In some embodiments, matcher 108 may be prohibited from accessing user software code 112 to ensure confidentiality of the user software code and the user.

It should be appreciated that any of the components shown in FIG. 1 may be combined in a single device or distributed across multiple devices in any manner. In some embodiments, a single device can be provided to a user (e.g., an organization) to check the user software code (e.g., all of the software code in the organization's software code repositories). The obfuscated reference software code data structures can be preloaded or generated on the single device and the single device can also include the matcher 108 to access obfuscated user software code data to perform the analysis.

With reference to FIG. 1, the reference software code 102 can be obtained from a plurality of sources, such as publicly available software code belonging to various companies or open-source software code repositories (e.g., GitHub, GitLab, Apache, Free Software Foundation, Stack Overflow). The reference software code 102 may be associated with one or more predefined deficiencies. For instance, the reference software code 102 may be subject to copyright restrictions, subject to trademark restrictions, under a license (e.g., GNU GPL, GNU, AGPL, Apache, BSD, MIT), and/or erroneous or insecure in some way that is already known, such as having been flagged in a vulnerability disclosure. The reference software code 102 may be written in any programming language (e.g., JavaScript, Java, Python, Go, Rust, Perl, C, C++, SQL).

In some embodiments, the reference software code 102 may be normalized to achieve a common data format. Normalizer 104 may be configured to receive reference software code 102 and perform one or more normalization operations to standardize the format of the reference software code 102. The normalization operations may include, but are not limited to, removing whitespace, removing comments, removing special characters or symbols, reformatting the reference software code, renaming one or more parameters or identifiers in the reference software code, or any combination thereof.

Generator 105 constructs one or more obfuscated reference software code data structures based on the normalized reference software code for use by matcher 108. In some embodiments, generator 105 may be configured to receive normalized reference software code from normalizer 104. Generator 105 may include snippeter 106a, which may extract a plurality of reference software code portions from the normalized reference software code. Generator 105 may further include obfuscator 106b, which may obfuscate the reference software code portions such that the raw software code is not discernible (e.g., cannot be reconstructed or derived) by matcher 108. Generator 105 may also include data structure generator 106c, which may create one or more obfuscated reference software code data structures using the obfuscated reference software code portions from obfuscator 106b.

Snippeter 106a may extract a plurality of reference software code portions from the normalized reference software code. In some embodiments, snippeter 106a uses a rolling window to extract a plurality of reference software code portions from the normalized reference software code. The rolling window may be configured to produce reference software code portions based on various software code portion specifications.

In some embodiments, the software code portion specification may specify a rolling window size (e.g., 3 lines of software code, 5 lines of software code). Accordingly, each reference software code portion extracted may comprise the same number of lines of software code (based on the rolling window size) and have overlapping lines of software code with a neighboring reference software code portion. For instance, a three-line rolling window may extract three-line reference software code portions from the normalized reference software code by incrementally moving one line at a time through the normalized reference software code and extracting three-line reference software code portions until all consecutive three-line windows of software code in the normalized reference software code are output as three-line reference software code portions. This way, if the normalized reference software code has N lines of software code, the resulting reference software code portions can include a first reference software code portion comprising Lines 1, 2, and 3 of the normalized reference software code, a second reference software code portion comprising Lines 2, 3, and 4 of the normalized reference software code, a third reference software code portion comprising Lines 3, 4, and 5 of the normalized reference software code, . . . and a (N−2)th reference software code portion comprising Lines (N−2), (N−1), and N of the normalized reference software code.

In some embodiments, the software code portion specification may specify a metric other than size. For instance, in some programming languages, it may be preferred to subdivide code into units other than lines. In those cases, the software code portion specification may specify a unit of code delimited by the reference software code's abstract syntax tree (e.g., a loop block, a function block, or an if statement).

In some embodiments, snippeter 106a may extract multiple sizes of reference software code portions for each normalized reference software code file. For example, snippeter 106a may produce a first plurality of reference software code portions of a first size (e.g., 3 lines) and a second plurality of reference software code portions of a second size (e.g., 5 lines). This way, a user can specify (e.g., using the front end 110c) a reference software code portion size to use based on the user's desired granularity for the comparison between the user software code 112 and the reference software code 102 to be. For instance, if the user would like matcher 108 to perform a less sensitive comparison, the user may specify to use 5-line reference software code portions as opposed to 3-line reference software code portions and the matcher can then retrieve the obfuscated reference software code data structure(s) corresponding to the 5-line reference software code portions for comparison. Alternatively, if the user would like matcher 108 to perform a more sensitive comparison, the user may specify to use 3-line reference software code portions as opposed to 5-line reference software code portions, and the matcher can then retrieve the obfuscated reference software code data structure(s) corresponding to the 3-line reference software code portions for comparison. In some embodiments, the preferred code specification may depend on the business risk tolerance of the company that employs the software engineer.

In some embodiments, the software code portion specification can be automatically determined rather than specified by any user. A given software program may have a preferred or optimal reference software code portion size for obtaining the best results from matcher 108. In some embodiments, the preferred reference software code portion size may depend on the programming language of the reference software code portion. For instance, a larger reference software code portion may be better suited for matcher 108 to detect a match between user software code and reference software code written in a verbose (e.g., Java), non-dense, or highly structured language (e.g., Go), while a smaller reference software code portion may be better suited for matcher 108 to detect a match between user software code and reference software code written in a relatively terse or dense language (e.g., Perl). Thus, the snippeter 106a may generate the reference software code portions based on the programming language of the reference software code.

In some embodiments, snippeter 106a may further normalize the normalized reference software code beyond what was performed by normalizer 104, such as by removing/standardizing variable names and non-semantically-meaningful syntax in the normalized reference software code.

Obfuscator 106b may receive reference software code portions from snippeter 106a and obfuscate the reference software code portions in such a way that it is difficult or impossible to discern (e.g., reproduce, reconstruct, derive) the raw reference software code from the obfuscated reference software code portions. In some embodiments, the reference software code portions are obfuscated by applying a cryptographic hash function to each reference software code portion to generate a hash value. In some embodiments, the cryptographic hash function is a SHA-256 hash. The cryptographic hash function may output obfuscated reference software code in hexadecimal.

In some embodiments, obfuscator 106b may obfuscate the plurality of reference software code portions using an oblivious RAM-based technique, a Homomorphic encryption technique, a Private Information Retrieval (PIR) protocol, or a Secure Multiparty Computation Protocol (SMCP). These obfuscation techniques may thoroughly and effectively obscure user software code, thus ensuring the confidentiality of the user software code.

In some embodiments, data structure generator 106c may generate one or more obfuscated reference software code data structures using the obfuscated reference software code portions. In some embodiments, the obfuscated reference software code data structures may comprise Bloom filters. A Bloom filter is a probabilistic data structure that provides an efficient way to check whether an element is a member a set of elements. Elements are hashed before being stored in a Bloom filter so that only a small amount of memory is required to store the elements. As a result, Bloom filters are highly capacitive and efficient data structures that can store information about a large volume of data (e.g., multiple terabytes of code), thereby enabling matcher 108 to perform comparisons in a relatively short period of time (e.g., less than a millisecond).

In some embodiments, the obfuscated reference software code data structures may comprise Cuckoo filters, Ribbon filters, XOR filters, or Binary Fuse Filters. These data structures may enable matcher 108 to perform accurate and efficient lookups. In some embodiments, the obfuscated reference software code data structures may comprise a hash table. Using a hash table may allow matcher 108 to perform efficient exact-match lookups. In some embodiments, the obfuscated reference software code data structures may comprise a key-value store, such as Redis or Memcached. Existing key-value stores may be simple and efficient to implement. In some embodiments, the obfuscated reference software code data structures may comprise conventional databases. The databases may be SQL-based or non-SQL-based. Conventional databases may be simple and inexpensive to implement. In some embodiments, the obfuscated reference software code data structures may comprise a cloud-based storage service. Any cloud-based storage service that can perform exact match lookups may be used (e.g., AWS, GCP, Azure). Using a cloud-based storage service may be simple and inexpensive to implement.

The obfuscated reference software code data structures generated by data structure generator 106c may be organized in various ways. For instance, obfuscated reference software code data structures may correspond to single reference software code files, multiple reference software code files, particular deficiencies, particular software code portion specifications, or any combination thereof. Other configurations of obfuscated reference software code data structures may be used in addition to those contemplated below.

In some embodiments, an obfuscated reference software code data structure (e.g., a Bloom filter) may be generated for each set of obfuscated reference software code portions having the same software code portion specification and corresponding to a single reference software code file. For instance, a first exemplary obfuscated reference software code data structure may contain all three-line obfuscated reference software code portions corresponding to a reference software code file, while a second exemplary obfuscated reference software code data structure may contain all five-line obfuscated reference software code portions corresponding to said reference software code file.

In some embodiments, an obfuscated reference software code data structure (e.g., a Bloom filter) may be generated for each set of obfuscated reference software code portions having the same software code portion specification and corresponding to a plurality of reference software code files. For instance, an obfuscated reference software code data structure may contain all three-line obfuscated reference software code portions corresponding to a plurality of reference software code files.

In some embodiments, an obfuscated reference software code data structure (e.g., a Bloom filter) may be generated for each set of obfuscated reference software code portions having the same software code portion specification and having the same deficiency. For instance, an obfuscated reference software code data structure may contain all three-line obfuscated reference software code portions corresponding to reference software code under a GPL license from a plurality of reference software code files.

In some embodiments, an obfuscated reference software code data structure (e.g., a Bloom filter) may be generated for each set of obfuscated reference software code portions corresponding to multiple software code portion specifications and corresponding to a single reference software code file. For instance, an obfuscated reference software code data structure may contain all three-line obfuscated reference software code portions and all five-line obfuscated reference software code portions corresponding to the same reference software code file. For a single data structure comprising multiple software code portion specifications, a user may not be required to specify a software code portion specification to return a match from matcher 108.

Client 109 may be used to generate the user query to matcher 108 and display the results output by matcher 108. Client 109 may comprise snippeter 110a for extracting user software code portions from user software code 112, obfuscator 110b for obfuscating the user software code portions, and front end 110c for both receiving user inputs and displaying matching results. Because the user software code 112 is obfuscated by obfuscator 110b, client 109 does not share the actual raw user software code 112 with the matcher 108 or any external devices, thus ensuring confidentiality of the user software code and the user.

With reference to FIG. 1, client 109 has access to user software code 112. User software code 112 may be provided to client 109 automatically or via a manual upload by a user. In some embodiments, a user (e.g., a software developer) can draft user software code 112 using front end 110c of client 109. Front end 110c may comprise a user interface such as a web interface or IDE (e.g., IntelliJ, VS Code, Xcode). In some embodiments, a user can also invoke matcher 108 to check user software code 112 for deficiencies and specify one or more parameters to be checked (e.g., one or more programming languages to check, one or more code licenses to check, one or more organizations whose code should be included or excluded from a check, a list of code portion sizes to check against, a list of abstract syntax tree granularities to check against, one or more normalization rules, or any combination thereof). In some embodiments, front end 110c may invoke matcher 108 automatically.

User software code 112 may comprise code that is partially or completely produced by machine learning models such as generative artificial intelligence models or large language models (LLMs). Exemplary LLMs may include GitHub Copilot or other open-source LLMs that provide equivalent functionality. Additionally, user software code 112 may comprise code produced by templates and rules in IDEs or code copied and pasted from various online public code repositories (e.g., Stack Overflow, GitHub). In some embodiments, client 109 may randomly select one or more user software code portions from user software code 112 to use for comparison by matcher 108. In another example, a user may identify one or more portions of user software code 112, for example via front end 110c of client 109, to be used for comparison by matcher 108. Using only some user software code portions of user software code 112 may enable more efficient processing and further ensure confidentiality of user software code 112 by making it more difficult for user software code 112 to be reconstructed.

In some embodiments, user software code 112 may be normalized to achieve a common data format. Normalizing user software code 112 may include removing whitespace, removing comments, removing special characters or symbols, reformatting the user software code, renaming one or more parameters or identifiers in the user software code, or any combination thereof. In some embodiments, user software code may be normalized by a normalizer sharing one or more characteristics with normalizer 104.

Client 109 may comprise snippeter 110a. Snippeter 110a may share any one or more characteristics with snippeter 106a. Snippeter 110a may be used to extract a plurality of user software code portions from user software code 112. The plurality of user software code portions may be extracted based on a user-specified software code portion specification (e.g., provided via the front end 110c). The user-specified software code portion specification may comprise a code portion size or a unit of code delimited by the code's abstract syntax tree (e.g., a loop block, a function block, or an if statement).

In some embodiments, snippeter 110a may extract user software code portions without using a rolling window, thus resulting in fewer user software code portions for a more efficient comparison. Each user software code portion may comprise the same number of lines of software code but may have no overlapping lines of software code with a neighboring software code portion. This way, if the user software code has N lines of software code, the resulting reference software code portions can include a first reference software code portion comprising Lines 1, 2, and 3 of the user software code, a second reference software code portion comprising Lines 4, 5, and 6 of the user software code, a third reference software code portion comprising Lines 7, 8, and 9 of the user software code, etc. In other embodiments, snippeter 110a may extract user software code portions via a rolling window.

Client 109 may also comprise obfuscator 110b. Obfuscator 110b may share any one or more characteristics with obfuscator 106b. Obfuscator 110b may receive user software code portions from snippeter 110a and obfuscate the user software code portions in such a way that it is difficult or impossible to discern the raw reference software code. In some embodiments, the user software code portions are obfuscated by applying a cryptographic hash function to the reference software code portions. In some embodiments, the cryptographic hash function is a SHA-256 hash. The cryptographic hash function may output obfuscated user software code in hexadecimal. The obfuscated user software code data output by obfuscator 110b may be received by matcher 108, but matcher 108 cannot manipulate the output to recover the raw original code due to the cryptographic property of the hash function.

In some embodiments, obfuscator 110b may obfuscate the plurality of reference software code portions using an oblivious RAM-based technique, a Homomorphic encryption technique, a Private Information Retrieval (PIR) protocol, or a Secure Multiparty Computation Protocol (SMCP). The obfuscation technique used by obfuscator 110b must be the same obfuscation technique used by obfuscator 106b in order for matcher 108 to be able to compare the obfuscated reference software code data structures to the obfuscated user software code data.

Client 109 may also include front end 110c. Front end 110c may comprise a web interface, an IDE (e.g., IntelliJ, VS Code, Xcode, etc.), or any other suitable mode of enabling a user to query matcher 108 and displaying the results generated by matcher 108. Front end 110c may be configured to allow a user to query matcher 108 with obfuscated user software code data received from obfuscator 110b. In some embodiments, front end 110c may be configured to allow a user to specify a plurality of parameters in the query. The plurality of parameters may include, but are not limited to, one or more programming languages to check, one or more code licenses to check, one or more organizations whose code should be included or excluded from a check, a list of code portion sizes to check against, a list of abstract syntax tree granularities to check against (e.g., a function block, a loop block, or an if statement), one or more normalization rules, or any combination thereof. In some embodiments, the specified parameters may be provided to matcher 108, which may use the plurality of parameters to select appropriate obfuscated reference software code data structures to compare to the obfuscated user software code data in the query. In some embodiments, generator 105 may not have generated reference software code data structures having the plurality of parameters specified by the user, or a repository of obfuscated reference software code data structures may not contain reference software code data structures corresponding to the plurality of parameters. If suitable reference software code data structures are not available for matching, front end 110c may display an error message indicating that the given combination of parameters is not supported. Alternatively, front end 110c may provide an instruction to generator 105 to generate a plurality of reference software code data structures having the specified parameters.

System 100 may further include matcher 108. Matcher 108 receives a query comprising obfuscated user software code data from front end 110c of client 109 and compares the obfuscated user software code data to one or more obfuscated reference software code data structures. The one or more obfuscated reference software code data structures may be those produced by generator 105 and/or may be from an existing repository of obfuscated reference software code data structures. The query may comprise, in addition to the obfuscated user software code data, a plurality of parameters including one or more programming languages to check, one or more code licenses to check, one or more organizations to check, one or more normalization rules, or any combination thereof. Because matcher 108 receives only obfuscated user software code data from client 109 rather than raw user software code, the confidentiality of the raw user software code is protected. In some embodiments, matcher 108 may receive obfuscated user software code data from a plurality of clients, which can further protect confidentiality by making it more difficult to reconstruct any one user's raw user software code.

In some embodiments, matcher 108 may be offered as a feature of an IDE. For instance, an IDE may include one or more machine learning models for generating code and matcher 108, such that the IDE can both generate code using the one or more machine learning models and check that the code meets user-specified criteria using matcher 108. In some embodiments, the IDE may automatically trigger matcher 108 without a user manually generating a query. For instance, the IDE may be configured to automatically query matcher 108 periodically or upon the occurrence of a predetermined trigger condition (e.g., an action by a user or a model).

In some embodiments, matcher 108 may be installed on a user device such as client 109 or on one or more remote devices. Matcher 108 may also be run on a cloud server. In some embodiments, if matcher 108 is run on a cloud server, matcher 108 may be accessed by client 109 through a hop intermediary service such as a VPN, a reverse proxy, or multi-hop relay service (e.g., INVISV Relay or Apple iCloud Private Relay). Such services may hide the user's identity and IP address of the computer making requests to matcher 108, such that matcher 108 does not learn where user queries originate. This may provide additional privacy and therefore further ensure the security of raw user software code. In some embodiments, each individual query received by matcher 108 may be made through a separate network flow through such a network intermediary service, such that each query appears to originate from a different party.

In some embodiments, matcher 108 may be run using a hardware-based secure enclave such as a Trusted Execution Environment (TEE). Using a TEE may further guarantee the security and privacy of the information contained in the user query received by matcher 108.

In some embodiments, if matcher 108 determines that there is a match between obfuscated user software code data and one or more of the obfuscated reference software code data structures, matcher 108 may identify one or more predefined deficiencies in the obfuscated user software code data (e.g., portions of the user software code may be subject to copyright restrictions, subject to trademark restrictions, under a license, and/or erroneous or insecure in some way that is already known). Matcher 108 may additionally provide an indication of the identified deficiencies to a user device such as client 109. The indication may be used to flag, in a software development environment at the user device, one or more lines of user software code associated with the obfuscated user software code data.

In some embodiments, front end 110c may display the results generated by matcher 108. Front end 110c may display the user software code and an indication of the lines of user software code matching reference software code based on a comparison of the obfuscated user software code data and the one or more obfuscated reference software code data structures (which are pre-associated with one or more deficiencies). The indication may include the deficiencies identified in the user software code by matcher 108. In some embodiments, the user software code may include one or more markings indicating that the user software code matched reference software code. For instance, user software code lines matching reference software code may be highlighted in various colors (e.g., each line of user software code that matches reference software code covered by a license may be assigned a highlight color corresponding to that license). The names of the corresponding licenses may be provided in the margins of the display. Alternatively or in addition, user software code lines matching reference software code may be indicated with brackets in the margins of the display. Furthermore, annotations may be provided as an overlay over the user software code or in the margins of the display. In some embodiments, annotations may be provided by hovering a cursor over the user software code. The user can then edit the user software code to eliminate the identified deficiencies. In some examples, the IDE can recommend new code to replace the portion of the user software code that contains the deficiencies for user selection. The new code does not contain the deficiencies (e.g., not being under any license or restriction, not containing any known vulnerabilities) but achieves the same result as the deficient code when inserted into the user software code. In some examples, the new code can be generated using one or more machine learning models or obtained from one or more repositories.

In some embodiments, the results displayed by front end 110c may include the source of the matching reference software code (e.g., a code repository such as GitHub or Stack Overflow). In some embodiments, the results may include an indication that the number of lines of user software code matching reference software code exceeds a predetermined threshold number of lines, wherein the predetermined threshold number of lines may be set by a user using front end 110c. Alternatively or in addition, the results may include an indication that the number of lines of user software code corresponding to a single reference software code file exceeds a predetermined threshold number of lines, wherein the predetermined threshold number of lines may be set by a user using front end 110c.

In some embodiments, front end 110c may be configured to allow a user to specify how to display matches detected by matcher 108. For instance, a user may choose to display an indication of lines of user software code matching reference software code only if the number of matching lines exceeds a predefined threshold number of lines, wherein the predefined threshold number of lines may be set by the user.

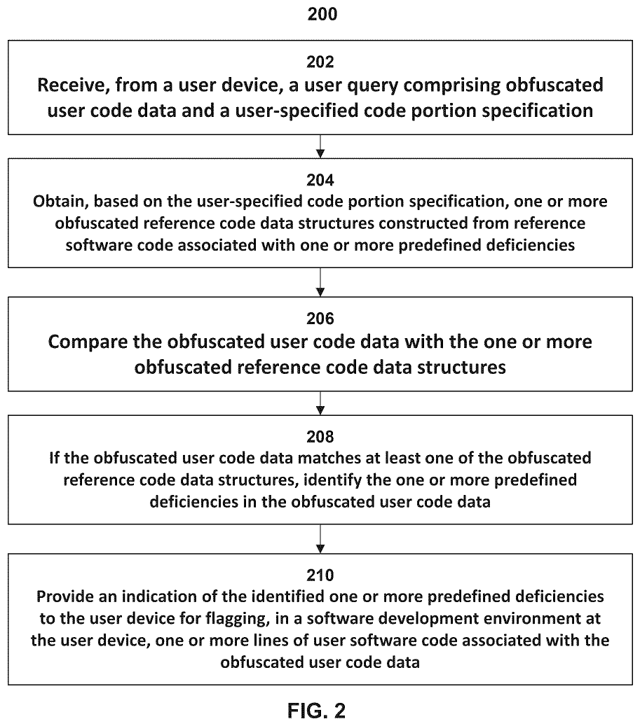

FIG. 2 illustrates an exemplary method 200 for securely identifying deficiencies in software code, according to some embodiments. Method 200 may be performed by any suitable code checking system, such as system 100 as described above with reference to FIG. 1. Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

Method 200 may begin at step 202, wherein step 202 comprises receiving, from a user device, a user query comprising obfuscated user software code data and a user-specified software code portion specification. In some embodiments, the obfuscated user software code data may be generated by extracting a plurality of user software code portions from user software code and constructing obfuscated user software code data by obfuscating the plurality of user software code portions. The user software code associated with the obfuscated user software code data is not accessible by the code checking system.

In some embodiments, the user-specified software code portion specification indicates a size or a code portion unit (e.g., a loop block, a function block, or an if statement) that an obfuscated reference software code data structure must have in order to compare the obfuscated reference software code data structure to the obfuscated user software code data.

In some embodiments, the user query may further comprise a plurality of parameters for the code checking system, wherein the plurality of parameters may comprise one or more programming languages to check, one or more code licenses to check, one or more organizations whose code should be included or excluded from a check, a list of code portion sizes to check against, a list of abstract syntax tree granularities to check against (e.g., a function block, a loop block, or an if statement), one or more normalization rules, or any combination thereof.

In some embodiments, the user device may comprise a laptop computer, a desktop computer, a tablet, a smartphone, or a server. The user device may be configured to allow a user to provide inputs such as user queries. Additionally, the user device may be configured to display the results of matching performed by the code checking system.

After receiving a user query, the method 200 may proceed to step 204. Step 204 includes obtaining, based on the user-specified software code portion specification, one or more obfuscated reference software code data structures constructed from reference software code associated with one or more predefined deficiencies. In some embodiments, the obfuscated reference software code data structures may be generated by ingesting reference software code, normalizing the reference software code, extracting a plurality of reference software code portions from the normalized reference software code, obfuscating the reference software code portions, and inserting the obfuscated reference software code portions into one or more obfuscated reference software code data structures, as discussed above with reference to FIG. 1. The obfuscated reference software code data structures may be constructed from reference software code associated with one or more predefined deficiencies, wherein the deficiencies can include being subject to copyright restrictions, being subject to trademark restrictions, being under a license, and/or being erroneous or insecure in some way that is already known. In some embodiments, the obfuscated reference software code data structures may be obtained from an existing repository of obfuscated reference software code data structures.

After obtaining one or more obfuscated reference software code data structures, the method 200 may proceed to step 206. Step 206 comprises comparing the obfuscated user software code data with the one or more obfuscated reference software code data structures.

The method 200 may proceed to step 208. Step 208 includes, if the obfuscated user software code data matches at least one of the obfuscated reference software code data structures, identifying the one or more predefined deficiencies in the obfuscated user software code data. If reference software code is associated with a predefined deficiency and the obfuscated reference software code data structure associated with the reference software code matches obfuscated user software code data, the user software code associated with the obfuscated user software code data must also contain that predefined deficiency.

After identifying the one or more predefined deficiencies in the obfuscated user software code data, the method 200 may proceed to step 210, wherein step 210 comprises providing an indication of the identified one or more predefined deficiencies to the user device for flagging, in a software development environment at the user device, one or more lines of user software code associated with the obfuscated user software code data. In some embodiments, flagging one or more lines of user software code associated with the obfuscated user software code data comprises highlighting, bracketing, annotating, or otherwise marking the code to indicate that the user software code matched reference software code. In some embodiments, the software development environment at the user device comprises a web interface or an IDE such as IntelliJ, VS Code, or Xcode.

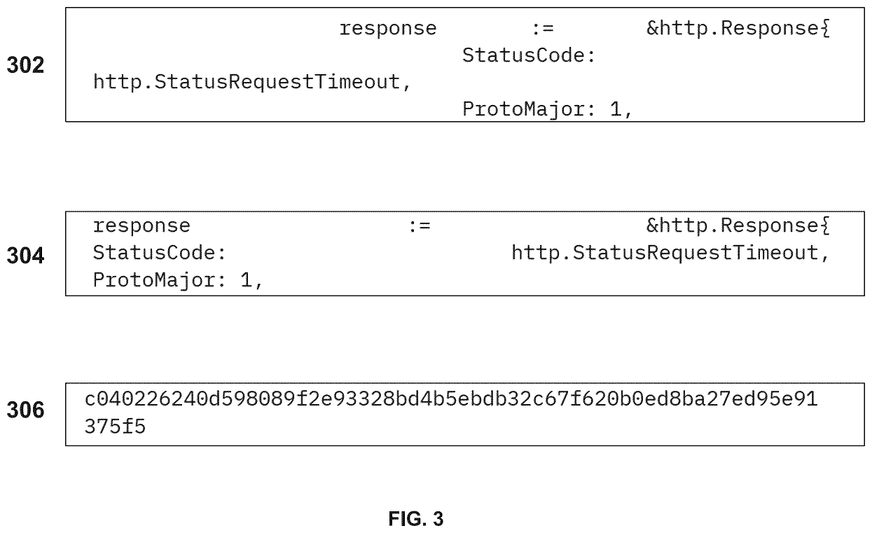

FIG. 3 illustrates obfuscation of an exemplary software code portion, according to some embodiments. Software code portions (e.g., reference software code portions or user software code portions) may be obfuscated to conceal the raw software code from the code checking system. In some embodiments, the software code portion may be normalized before obfuscation.

Block 302 illustrates an exemplary software code portion comprising raw software code. The software code portion may be extracted from reference software code or user software code. As shown in block 302, the raw software code may be written in a language that includes formatting elements such as whitespace.

Block 304 illustrates an exemplary normalized software code portion. The software code portion shown may be a reference software code portion or a user software code portion. In some embodiments, the software code portion may be normalized before obfuscation to standardize the format of the software code. As shown in block 304, normalization may comprise removing whitespace. In some embodiments, normalization may also include removing comments, removing special characters or symbols, reformatting the reference software code, and/or renaming one or more parameters or identifiers in the reference software code. The specific normalization operations performed may depend on the programming language of the raw software code.

Block 306 illustrates an exemplary obfuscated software code portion. The obfuscated software code portion shown may be a reference software code portion or a user software code portion. In some embodiments, obfuscation may be performed by applying a cryptographic hash function (e.g., a SHA-256 hash) to the code portion. In block 306, the hash output is shown in hexadecimal. The code checking system receives only the hash output and cannot invert the hash to recover the raw software code due to the cryptographic property of the hash function. In some embodiments, other obfuscation techniques may be used, such as an oblivious RAM-based technique, a Homomorphic encryption technique, a Private Information Retrieval (PIR) protocol, or a Secure Multiparty Computation Protocol (SMCP). The obfuscated software code portion shown in block 306 may be used to create an obfuscated data structure.

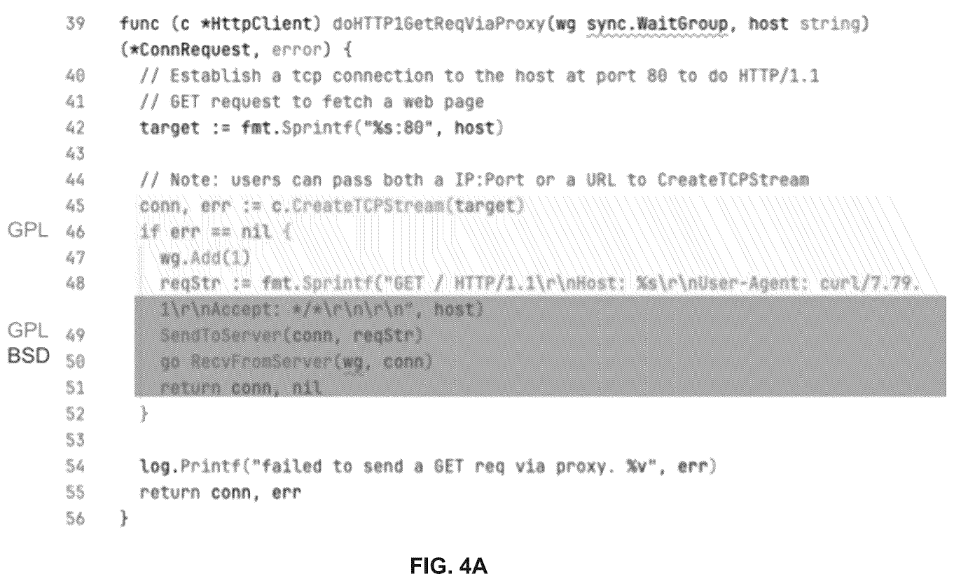

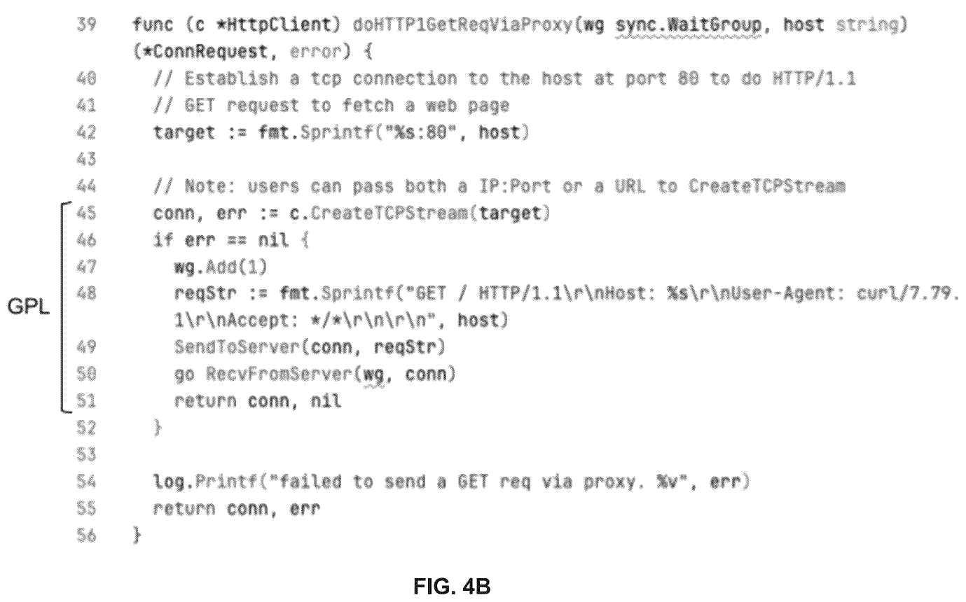

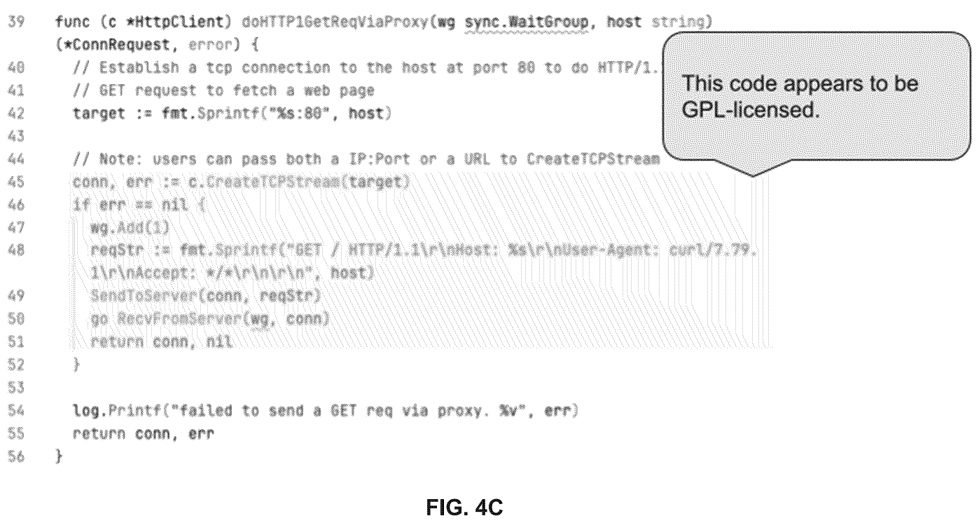

FIG. 4A illustrates an exemplary indication of an identified deficiency in software code, according to some embodiments. In some embodiments, an indication of one or more identified deficiencies in user software code may be provided, for example via a user interface of the front end 110c (e.g., a user interface of the IDE), as discussed above with reference to FIG. 1. The indication may comprise the user software code and one or more markings corresponding to deficiencies identified in the user software code by a code checking system. In some embodiments, the indication may be displayed on a web interface or an IDE such as IntelliJ, VS Code, or Xcode. The one or more deficiencies in the code may include being subject to copyright restrictions, being subject to trademark restrictions, being under a license, and/or being erroneous or insecure in some way that is already known.

In some embodiments, one or more deficiencies identified in the user software code may be denoted by highlighting the portions of the user software code having identified deficiencies and/or by identifying the specific deficiency in the margins of the display region. For instance, as shown in FIG. 4A, a first portion of the code is under a GPL license and is highlighted in a first color, while a second portion of the code is under a BSD license and is highlighted in a second color. The names of the corresponding licenses are also included in the margins of the display region.

FIG. 4B illustrates an exemplary indication of an identified deficiency in software code, according to some embodiments. As discussed above with reference to FIG. 4A, an indication of one or more identified deficiencies in user software code may be provided, wherein the indication may include the user software code and one or more markings corresponding to deficiencies identified in the user software code.

In some embodiments, one or more deficiencies identified in the user software code may be denoted by bracketing the portions of the user software code having identified deficiencies and/or by identifying the specific deficiency in the margins of the display region. For instance, as shown in FIG. 4B, a portion of the code is enclosed in a left bracket in the margins and labeled in the margins as being under a GPL license.

FIG. 4C illustrates an exemplary indication of an identified deficiency in software code, according to some embodiments. As discussed above with reference to FIGS. 4A and 4B, an indication of one or more identified deficiencies in user software code may be provided, wherein the indication may include the user software code and one or more markings corresponding to deficiencies identified in the user software code.

In some embodiments, one or more deficiencies identified in the user software code may be denoted by one or more comments indicating the deficiencies. For instance, as shown in FIG. 4C, a portion of the code is highlighted and a comment corresponding to the highlighted lines indicates that the code is subject to a GPL license.

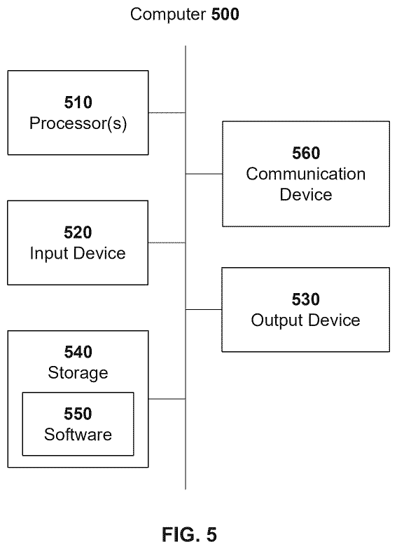

In some embodiments, the disclosed systems and methods utilize or may include a computer system. FIG. 5 illustrates an exemplary computing system according to some embodiments. Computer 500 can be a host computer connected to a network. Computer 500 can be a client computer or a server. As shown in FIG. 5, computer 500 can be any suitable type of microprocessor-based device, such as a personal computer, workstation, server, or handheld computing device, such as a phone or tablet. The computer can include, for example, one or more of processor 510, input device 520, output device 530, storage 540, and communication device 560. Input device 520 and output device 530 can correspond to those described above and can either be connectable or integrated with the computer.

Input device 520 can be any suitable device that provides input, such as a touch screen or monitor, keyboard, mouse, or voice-recognition device. Output device 530 can be any suitable device that provides an output, such as a touch screen, monitor, printer, disk drive, or speaker.

Storage 540 can be any suitable device that provides storage, such as an electrical, magnetic, or optical memory, including a random-access memory (RAM), cache, hard drive, CD-ROM drive, tape drive, or removable storage disk. Communication device 560 can include any suitable device capable of transmitting and receiving signals over a network, such as a network interface chip or card. The components of the computer can be connected in any suitable manner, such as via a physical bus or wirelessly. Storage 540 can be a non-transitory computer-readable storage medium comprising one or more programs, which, when executed by one or more processors, such as processor 510, cause the one or more processors to execute methods described herein.

Software 550, which can be stored in storage 540 and executed by processor 510, can include, for example, the programming that embodies the functionality of the present disclosure (e.g., as embodied in the systems, computers, servers, and/or devices as described above). In one or more examples, software 550 can include a combination of servers such as application servers and database servers.

Software 550 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 550 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating on the network. Software 550 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a,” “an,” and “the” include the plural reference unless the context clearly dictates otherwise. Reference to “about” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of any patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for securely identifying deficiencies in software code, comprising:
by a code checking system:
receiving, from a user device, a user query comprising obfuscated user software code data and a user-specified software code portion specification;
obtaining, based on the user-specified software code portion specification, one or more obfuscated reference software code data structures constructed from reference software code associated with one or more predefined deficiencies;
comparing the obfuscated user software code data with the one or more obfuscated reference software code data structures;
if the obfuscated user software code data matches at least one of the obfuscated reference software code data structures, identifying the one or more predefined deficiencies in the obfuscated user software code data; and
providing an indication of the identified one or more predefined deficiencies to the user device for flagging, in a software development environment at the user device, one or more lines of user software code associated with the obfuscated user software code data.

2. The method of claim 1, wherein the one or more obfuscated reference software code data structures are constructed by:
extracting, via a rolling window having a specification equivalent to the user-specified software code portion specification, a plurality of reference software code portions from the reference software code; and
constructing the one or more obfuscated reference software code data structures by obfuscating the plurality of reference software code portions.

3. The method of claim 2,
wherein each reference software code portion of the plurality of reference software code portions comprises the same number of lines of software code; and
wherein each reference software code portion has overlapping lines of software code with a neighboring reference software code portion.

4. The method of claim 1, wherein the obfuscated user software code data is generated at the user device by:
extracting, at the user device, a plurality of user software code portions from the user software code; and
constructing obfuscated user software code data by obfuscating the plurality of user software code portions.

5. The method of claim 4,
wherein each user software code portion comprises the same number of lines of software code; and
wherein each user software code portion has no overlapping lines of software code with a neighboring user software code portion.

6. The method of claim 1, wherein the one or more lines of user software code associated with the obfuscated user software code data are not accessible by the code checking system.

7. The method of claim 1, wherein the one or more lines of user software code associated with the obfuscated user software code data are generated by a machine-learning or AI model.

8. The method of claim 1, wherein the one or more predefined deficiencies comprise:
one or more copyright restrictions,
one or more trademark restrictions,
one or more licenses,
one or more vulnerabilities,
or any combination thereof.

9. The method of claim 1, further comprising:
normalizing the reference software code.

10. The method of claim 9, wherein normalizing the reference software code comprises:
removing one or more whitespaces from the reference software code,
removing one or more comments from the reference software code,
removing one or more special symbols from the reference software code,
reformatting the reference software code,
renaming one or more parameters or identifiers in the reference software code,
or any combination thereof.

11. The method of claim 1, wherein the one or more obfuscated reference software code portions are obfuscated by performing a cryptographic hash function on each reference software code portion of the plurality of reference software code portions.

12. The method of claim 1, wherein each obfuscated reference software code data structure of the one or more obfuscated reference software code data structures comprises a Bloom filter, a Cuckoo filter, a Ribbon filter, an XOR filter, or a Binary Fuse Filter.

13. The method of claim 1, wherein the user query comprises a plurality of parameters comprising:
one or more programming languages to check,
one or more code licenses to check,
one or more organizations to check,
one or more normalization rules,
or any combination thereof.

14. The method of claim 13, wherein the one or more obfuscated reference software code data structures are selected based on the plurality of parameters in the user query.

15. The method of claim 1, wherein flagging the one or more lines of user software code associated with the obfuscated user software code data comprises highlighting, marking, or annotating the one or more lines of user software code.

16. The method of claim 1, wherein the plurality of reference software code portions are obfuscated using an Oblivious RAM-based technique, a Homomorphic encryption technique, a Private Information Retrieval protocol, or a Secure Multiparty Computation Protocol (SMCP).

17. The method of claim 1, wherein the code checking system is installed on the user device or one or more remote devices.

18. The method of claim 1, wherein the code checking system is automatically triggered by the software development environment or IDE.

19. A system for securely identifying deficiencies in software code, the system comprising one or more processors configured to cause the system to:
receive, from a user device, a user query comprising obfuscated user software code data and a user-specified software code portion specification;
obtain, based on the user-specified software code portion specification, one or more obfuscated reference software code data structures constructed from reference software code associated with one or more predefined deficiencies;
compare the obfuscated user software code data with the one or more obfuscated reference software code data structures;
if the obfuscated user software code data matches at least one of the obfuscated reference software code data structures, identify the one or more predefined deficiencies in the obfuscated user software code data; and
provide an indication of the identified one or more predefined deficiencies to the user device for flagging, in a software development environment at the user device, one or more lines of user software code associated with the obfuscated user software code data.

20. A non-transitory computer readable storage medium storing instructions that, when executed by one or more processors of an electronic device, cause the device to:
receive, from a user device, a user query comprising obfuscated user software code data and a user-specified software code portion specification;
obtain, based on the user-specified software code portion specification, one or more obfuscated reference software code data structures constructed from reference software code associated with one or more predefined deficiencies;
compare the obfuscated user software code data with the one or more obfuscated reference software code data structures;
if the obfuscated user software code data matches at least one of the obfuscated reference software code data structures, identify the one or more predefined deficiencies in the obfuscated user software code data; and
provide an indication of the identified one or more predefined deficiencies to the user device for flagging, in a software development environment at the user device, one or more lines of user software code associated with the obfuscated user software code data.
